(19) United States
(12) Patent Application Publication
(10) Pub. No.: US 2009/0121486 A1
(43) Pub. Date: May 14, 2009

(54) Tidal Power System

(76) Inventor: Declan J. Ganley, Galway (IE)

Correspondence Address: The Marbury Law Group, PLLC, 11800 Sunrise Valley Drive, Suite 1000, Reston, VA, 20191, US

(21) Appl. No.: 11/870,690

(22) Filed: Oct. 11, 2007

(51) Int. Cl. F03B 13/26

(52) U.S. Cl. 290/53

(57) ABSTRACT

Systems and methods for harnessing energy from ocean tides use the rise in water level to lift a buoyant mass to an elevation and then use the weight of the mass to pressurize a working fluid, such as water, used to motivate a turbine generator to produce electricity. The extra weight of the buoyant mass pressurizes the working fluid to greater pressure and velocity than possible using only the static head of the tide.

### FIELD OF THE INVENTION

The present invention relates to environmentally friendly methods for generating electrical power, and more specifically to systems and methods for extracting power from ocean tides.

### BACKGROUND

Recent concerns about global warming have increased the interest in methods for generating electrical power which do not emit greenhouse gases. Additionally, global demand for energy has raised the price of coal, oil and natural gas, shifting the economic balance more in favor of alternative energy sources. Consequently, there is renewed interest in environmentally sound energy producing technologies.

One source of renewable energy that has received some attention is the energy present in ocean tides. The gravitation pull of the moon and the sun causes twice daily tidal shifts in the sea surface level which, in combination with geography, can result in strong currents and dramatic changes in sea level. The energy in tidal forces is substantial, and in some locations is highly focused into strong currents and large changes in sea level.

Heretofore there have been two basic approaches to harnessing tidal energy: barrage systems and tidal stream systems.

Barrage systems harness tidal energy by building a barrage that temporarily restrains the tidal flow into and/or out of a bay or river basin, and then captures energy from the flow of water through the barrage in water turbines. Similar to a hydroelectric dam, turbines in the barrage exploit the potential energy in the static head or pressure caused by the difference in height of the water on either side of the barrage. Barrage tidal power systems can generate electricity on both the ebb and flood portions of the tide cycle. Perhaps the best known barrage tidal power system is the 240 MW (peak) system that has operated on the Rance River in France since 1966. However, due to the size and complexity of building a strong enough barrage across an inlet or bay to hold back the tide and withstand storms, barrage tidal power systems have a high capital cost for their power output. Consequently, even though the tides are free, the time required to obtain a sufficient economic return on the initial investment can be quite long. Also, barrage systems are limited to locations where there is no marine traffic since the barrage must span the opening to the river, bay, inlet or basin that serves as the tidal reservoir.

In contrast to barrage systems, tidal stream power systems harness the power in tidal flows by placing a propeller or turbine in the stream. In geographic locations where tidal flow is concentrated into a channel, the resulting currents can be swift. Since water is 832 times denser than air, the amount of power in such tidal flows is tremendous. In tidal stream power systems, a water turbine connected to a generator is anchored to the seabed in line with the direction of flow. Flow through the water turbine turns the generator, producing electricity much like a wind turbine. A number of tidal flow systems have been tested, including the Roosevelt Island Tidal Energy Project located in the East River between Roosevelt Island and Queens, N.Y. While the required structures are not as large as barrage tidal power systems, they require anchoring complex equipment to the seabed with sufficient structure to withstand the tremendous hydrodynamic forces generated by tidal currents and storms. Such structures are expensive, leading to high initial investments. Additionally, turbines and generators require periodic maintenance which, given that they are located under swift moving water, leads to high operating costs.

Nevertheless, ocean tides remain an endless source of nonpolluting energy that awaits the proper technology to harness it for the benefit of mankind.

### SUMMARY

The various embodiments provide systems and methods for harnessing energy available in ocean tides by using the rise in water level to lift a buoyant mass to an elevation and then using the mass to pressurize a working fluid, such as water, which can be used to motivate a turbine generator to produce electricity efficiently. By using the extra weight of the buoyant mass to pressurize the working fluid, the working fluid can be conveyed to the turbine at greater pressure and velocity than possible using only the static head of the tide. The greater pressure can also be used to move the energy conversion equipment, (e.g., turbine and generator) above the water level, thereby reducing capital costs and facilitating maintenance.

### BRIEF DESCRIPTION OF THE DRAWINGS

The features and nature of the present invention will become more apparent from the detailed description set forth below when taken in conjunction with the drawings in which like reference characters identify correspondingly throughout and wherein:

FIG. 1 is a system block diagram of an embodiment of the present invention.

FIGS. 2A and 2B are perspective and overhead views of an embodiment of a buoyant mass suitable for use in the system illustrated in FIG. 1.

FIG. 3 is a perspective view of an assembly of portion of the system illustrated in FIG. 1.

FIG. 4 is a perspective view of an alternative configuration for a compression cylinder for use in an embodiment.

FIG. 5 is a perspective view of an alternative embodiment of the present invention.

FIG. 6 is a perspective view of the embodiment illustrated in FIG. 5 showing a position of the buoyant mass during operation.

FIG. 7 is a perspective view of an alternative embodiment of the present invention.

FIGS. 8-10 are perspective views of an alternative embodiment employing different buoyant masses.

FIG. 11 is a process flow diagram for a method of operating the various embodiments and generating electricity from tidal energy.

FIG. 12 is a process flow diagram for a method of generating electricity from tidal energy on both rising and falling tides.

### DETAILED DESCRIPTION

The various embodiments will be described in detail with reference to the accompanying drawings. Wherever possible, the same reference numbers will be used throughout the drawings to refer to the same or like parts.

As discussed in the Background, current systems for harnessing tidal energy require large capital investments, the returns on which are slow to accumulate due to the relatively low generating capacity of the systems. The power generating efficiency of barrage systems are limited by the static head of the tidal rise, while tidal stream systems are limited by the current speed. Both systems suffer from the costs and complexities of positioning complex rotating equipment under seawater.

To overcome these shortcomings, the present invention introduces a new technology for harnessing tidal energy which takes advantage of the lifting capacity of water to store potential energy that can be converted into electricity using equipment located above water level. In overview, a large mass is raised to the height of high tide by floating it on seawater. Then, as the tide ebbs and the water level drops towards low tide, the potential energy stored in the height of the large mass above the water level is used to pressurize a working fluid, such as sea water, by pressing on a column of the fluid. The pressurized fluid is used to drive a turbine at greater pressures and greater speed that achievable in either a barrage or stream tidal system. The turbine drives a generator which produces electricity. Since the fluid is pressurized by the weight of the buoyant mass (plus the static head of the fluid itself), some of the pressure can be used to lift the working fluid above water level, enabling the turbine and generator to be positioned out of the water. This technology is further explained in the following description of example embodiments some of which are illustrated in the attached figures.

For simplicity, the following description of the example embodiments will refer to the working fluid as “water” or “seawater” as that is the working fluid used in the embodiments. However, such references are for illustrative purposes only. Indeed, any fluid, including gasses, condensable gasses, two-phase fluids and nonvolatile fluids may be used as the working fluids with little change to the embodiments. In some implementations, gasses (e.g., air) or nonvolatile fluids (e.g., oil) may provide operational or efficiency advantages over water. Therefore, such references are not intended to limit the scope of the invention or the claims to water-based working fluids.

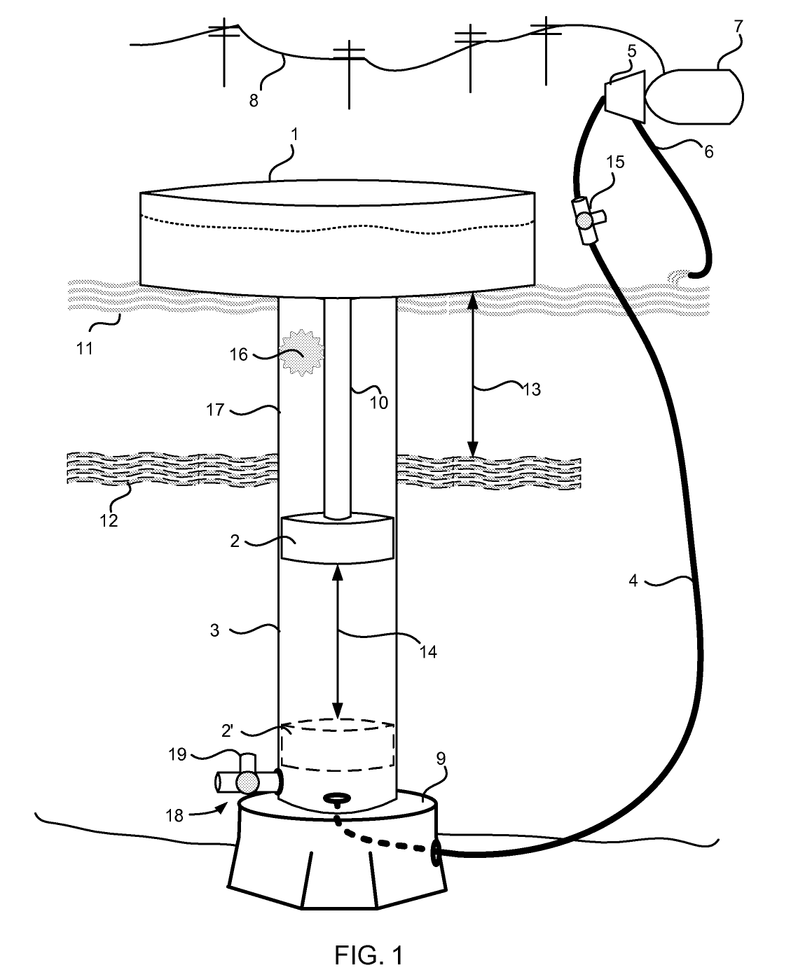

References herein to a “buoyant mass” and “floatable mass” are intended to refer simply to any mass which can be floated as a whole on seawater. As illustrated in FIGS. 1 and 8-10, this mass can be an assembly of practically any size, shape, material and construction. The term refers to the assembly as a whole, and is not intended to infer that some or all of the material comprising the mass are buoyant (the opposite is more likely). Similarly, references to a “fluid column” and “compression cylinder” are intended as illustrative examples of a component of the system, and not intended to imply that the components must be columnar or cylindrical in shape. In fact, such components may be square, rectangular, triangular or irregular in cross-sectional shape and perform as well as the cylindrical structures illustrated in the figures.

In many coastal locations around the globe the daily rise and fall of tide can be substantial. Tides of over 10 feet are common and some locations, like the Bay of Fundy, experience twice daily tides of more than 30 feet. The change in sea level combined with the lifting power of water provides opportunities for creating large amounts of potential energy that can be readily converted into electricity.

The potential energy in a buoyant mass floating at high tide is equal to

E=hMg Eq. 1;

where: h is the height of the tide (i.e., the difference between high and low tide levels); M is the mass of buoyant mass; and g is the acceleration due to gravity=9.81 meters per second squared at the Earth's surface. From this equation it is easy to see that energy available for capture from the tides can be increased by selecting a location that experiences a large tide and by increasing the mass that is elevated by the tide. Since the lifting capacity of water is nearly limitless, the amount of potential energy that can be created by tides is substantial. Since the tides are free, this potential energy represents an endless source of power if it can be harnessed.

An example embodiment of a tidal power system is illustrated in FIG. 1. A large buoyant mass 1 is coupled to a fluid compressing member such as a piston 2 within a compression cylinder 3 filled with a working fluid, such as seawater. The force of the weight of the buoyant mass 1 applied to the piston 2 pressurizes the seawater within the compression cylinder 3. Pressurized seawater can flow via a fluid conduit 4 that leads from the compression cylinder 3 to the inlet of a turbine 5, and from the outlet of the turbine 5 via an effluent conduit 6 to a discharge. Energy in the pressurized seawater is converted to kinetic energy in the turbine 5 which turns an electric generator 7 to produce electricity that is applied to a power grid 8.

The tidal power system embodiment illustrated in FIG. 1 may be located within a bay, cove, estuary or other coastal feature that experiences a sizable tidal fluctuation. The assembly may be fixed to the sea bed, such as on a foundation 9 that supports the compression cylinder 3. As sea level rises from the low tide level 12 to the high tide level 11, the buoyant mass 1 rises with it to a lifted position. As the buoyant mass 1 rises, it raises the piston 2 within the compression cylinder 3 which is filled with sea water. Raising the buoyant mass 1 to the high tide level 11 stores potential energy equal to the total mass times the tidal difference 13 times acceleration due to gravity (see Eq. 1). This potential energy can then be extracted by the piston 2 pressuring the working fluid in the compression cylinder 3 and driving the fluid through a stroke length 14 that is approximately equal to the tidal difference 13.

The potential energy stored in the elevated buoyant mass 1 may be stored for later exploitation by suspending the mass at the high tide level 11 as the tide recedes. This may be accomplished by a mechanical breaking system 16 that physically supports the buoyant mass 1 on a support structure, which may be an extension cylinder 17 on top of the compression cylinder 3. Such a mechanical breaking system 16 may be a mechanical latch assembly (not shown), a gear and break system (illustrated), a chain and pulley system (not shown), or any other well known mechanism for restricting the downward motion of the buoyant mass 1. For example, the mechanical breaking system 16 may be in the form of a gear system mounted on the upper support structure 17 that engages the shaft 10 with a sprocket or gear configured with a size and strength sufficient to support the weight of the buoyant mass and shaft 10. A break coupled to the gear system allows a regulator to halt the downward movement of the buoyant mass 1. Additionally, the break in the mechanical breaking system 16 can be configured to be controllable so as to allow control of the rate of descent, and thus regulate the rate at which energy is extracted from the system.

Hydraulics can also be used to suspend the buoyant mass 1 at an elevated position by limiting the rate at which the working fluid is expelled from the compression cylinder 3, such as by providing a computer-controlled or pressure-controlled outlet valve 15 in the fluid conduit 4. By closing the outlet valve 15, the working fluid will resist further motion of the piston 2, thereby suspending the buoyant mass 1. By opening and closing the outlet valve 15 by means of a controller, such as a pressure controller on the valve itself, the fluid pressure and velocity of the working fluid entering the turbine 5 can be controlled at or near optimum values.

By holding the buoyant mass 1 above sea level after the tide drops below the high tide level 11, pressure can be raised in the compression cylinder 3 to a level sufficient to provide optimum fluid pressure and velocity values at the turbine 5 inlet. Once this pressure is achieved, then the buoyant mass 1 may be allowed to descend at a rate controlled by a mechanical breaking system 16 or an outlet valve 15 (or both), to maintain the optimum fluid pressure and velocity values at the turbine 5 inlet through out the stroke length (sometimes referred to herein as the power stroke). The rate of decent of the buoyant mass 1 can be regulated until the piston 2 reaches the bottom of the stroke length 14, when the buoyant mass 1 will reach sea level 12 and begin to float. At this point the outlet valve 15 may be closed and the turbine 5 stopped.

Additionally, by holding the buoyant mass 1 in place after the tide drops below the high tide level 11 (such as using a mechanical breaking system 16 and/or outlet valve 15) the potential energy in the system can be stored for minutes or hours. In this manner, energy in the tides can be saved for a few hours until is needed most by the grid 8, such as for providing “peak power.” While energy cannot be stored as potential energy beyond one tide cycle in the embodiment illustrated in FIG. 1, the time between minimum and peak demands on a power grid 8 is often less than the time between high and low tide. Thus, the system can be used as a peak power topping generator.

Once the piston 2 is at the bottom of its stroke 14 (i.e., when the piston is in the position illustrated as piston 2′) and the buoyant mass 1 is floating, seawater needs to be reintroduced into the pressure cylinder 3. This allows the compression cylinder 3 to fill as the buoyant mass 1 rises with the tide. This can be accomplished by an inlet valve 18 which may be controlled by a remotely activated controller 19. When the system is in the power stroke (i.e., the working fluid is being expelled through the outlet conduit 4), the inlet valve 18 will be maintained in the closed position. While FIG. 1 illustrates the inlet valve 18 positioned at the bottom of the compression cylinder 3, this valve may be alternatively positioned in the piston 2 or the foundation 9.

In an alternative embodiment, the inlet valve 18 and outlet valve 15 may be both positioned in the flow path of the outlet conduit 4 so it can serve as both an inlet and outlet conduit. This embodiment may simplify the valve and piping systems. This embodiment allows using fresh water as the working fluid in the compression cylinder 3, which may provide maintenance and reliability advantages. In such an embodiment, the turbine outlet conduit 6 would direct fresh water effluent from the turbine 5 into a holding pond or tank (not shown separately) during the power stroke. Then, during the recharge stroke while the tide raises the buoyant mass 1, the inlet valve 18 can open to direct fresh water from the holding pond or tank through the inlet/outlet conduit 4 into the compression cylinder 3. In this embodiment, the inlet valve 18 and outlet valve 15 may be provided as a single two-way valve that alternatively connects the outlet conduit 4 to the turbine 5 inlet or to the holding pond or tank.

In yet a further alternative embodiment, power may be generated during the rising tide by using the vacuum generated in the compression cylinder 3 as the piston 2 is raised with the buoyant mass 1. In this embodiment, inlet water is drawn from the sea, such as via the effluent conduit 6 back through the turbine 5 and then through the outlet conduit 4 into the compression cylinder 3. In this manner, power can be generate during both ebb and flood tides.

In the embodiment illustrated in FIG. 1, conventional equipment and systems may be used for the turbine 5, generator 7, and valves 15, 18. The outlet conduit 6 may be of conventional construction such as of steel and/or concrete piping whose diameter and wall thickness may be determined by the flow rate and pressure desired at the turbine 5 inlet. Similarly, the turbine outlet conduit 6 may be of conventional design such as piping and/or an open canal sized to accept the turbine outlet at the optimum turbine outlet pressure. The foundation 9 may be of conventional construction, such as reinforced concrete, which may be formed in place, or prefabricated, floated to the site and then sunk to the seabed.

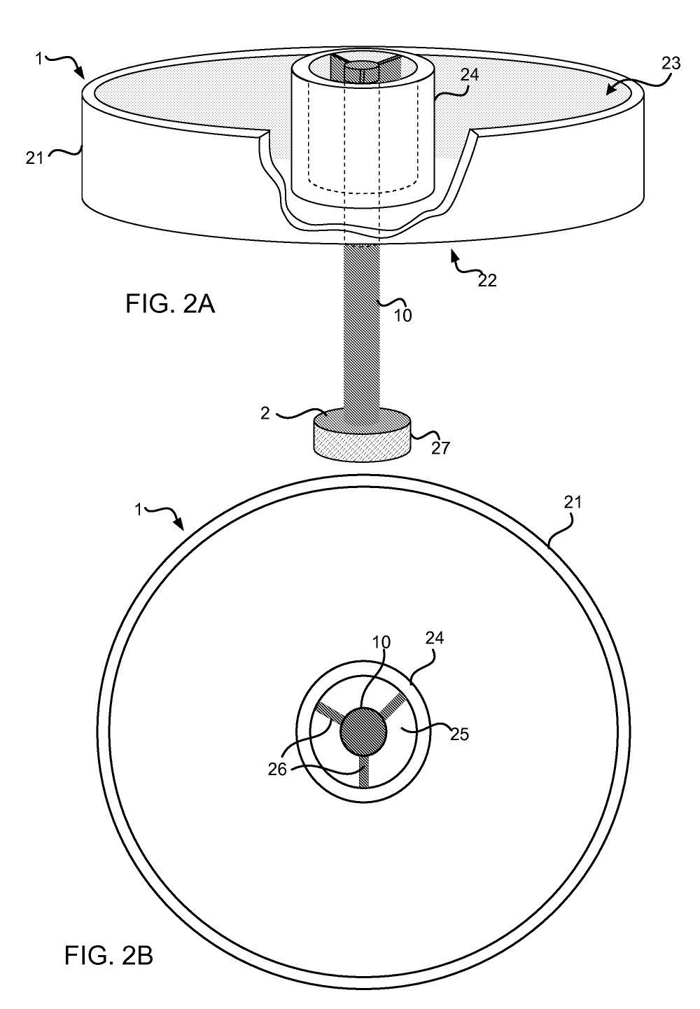

As mentioned previously, the buoyant mass 1 can be of any design and construction. FIGS. 2A and 2B illustrate a simple example of a design suitable for use in the embodiment illustrated in FIG. 1. Referring to FIG. 2A, the buoyant mass 1 may be in the form of a large container defined by an outer wall 21 and a bottom 22 which defines an interior volume 23. While FIGS. 1, 2A and 2B show the buoyant mass 1 as being cylindrical in shape, the structure can be any shape including rectangular, oval, and elongated streamlined (such as with pointed ends) to reduce resistance as tidal currents pass beneath it.

The buoyant mass 1 may be of any conventional construction, including for example steel and reinforced concrete (and combinations of both). For example, in an embodiment expected to have cost advantages, the outer wall 21 and bottom 22 may be formed of reinforced concrete using conventional methods for creating such structures. Once formed, the buoyant mass 1 can be floated to the tidal site for assembly into the tidal power system. Once installed in the power system, the interior volume 23 can be filled with ballast to increase the total mass of the assembly. For example, the interior volume may be filled with dirt, mud and rocks, such as may be dredged from the seabed (e.g., during construction of the foundation 9 or from maintaining shipping channels). As another example, the interior volume 23 may be filled with sea water such as by means of a pump or inlet valve (not shown). In yet another embodiment, fresh water may be used as the ballast so that the buoyant mass 1 may also serve as a stand by water reservoir. The interior volume 23 can be filled with ballast to the point that the assembly just floats, which maximizes the weight of the buoyant mass 1.

While FIGS. 1, 2A and 2B show the buoyant mass 1 as being uncovered, in some embodiments it may be desired to provide a cover or roof. For example, if sea or fresh water is used as ballast, a cover may be desired to minimize loss of the water due to evaporation. If dirt and/or mud are used as ballast, a plastic or concrete cover may be desired to prevent the system from becoming a source of dust and grit in the local environment.

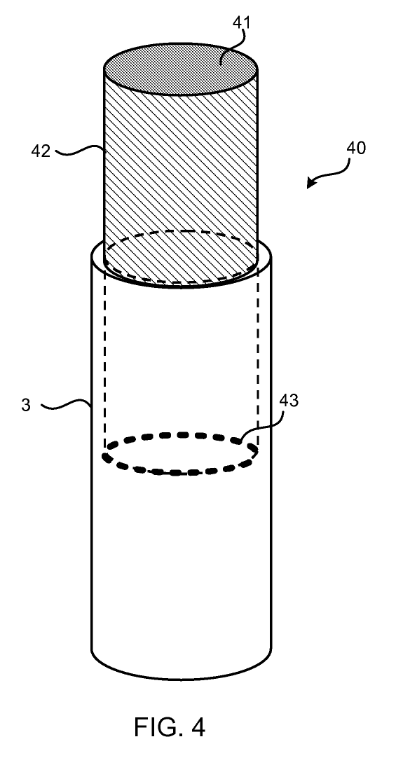

The buoyant mass 1 may be coupled to the compression member and compression cylinder 3 in a variety of way (see for example FIGS. 4-10). In the embodiment illustrated in FIGS. 1, 2A and 2B, the compression member is a piston 2 which is connected to the buoyant mass 1 by a shaft 10. In the embodiment illustrated in FIG. 1, the shaft 10 is coupled to the bottom 22 of the buoyant mass 1 and is long enough to enable the piston 2 to travel through the entire tidal stroke 14 before the buoyant mass 1 contacts the top of the compression cylinder extension 17. As illustrated in FIG. 1, the shaft may include features (e.g., gear teeth) for engaging a mechanical breaking system 16. Although not illustrated in the figures, the shaft 10 may also include alignment support features such as roller spacers at different points along its length in order to help maintain the vertical alignment of the piston 2 in the compression cylinder 3.

In the various embodiments, the circumference of the piston 2 (or other compression member) may be coated, clad or covered with a seal structure 27 to help establish a relatively water tight seal with the compression cylinder 3. The seal structure 27 may be a compressible layer or structure, such as rubber, foam or plastic. Alternatively, the seal structure 27 may be a series of sealing rings, like flexible rubber ribs or rings. In another alternative, the seal structure 27 may be a series of labyrinth grooves to increase resistance to water flowing vertically between the outer surface of the piston 2 and the compression cylinder 3. In yet another embodiment, the seal structure 27 may be a spring preloaded seal ring in which springs within the piston 2 press radially outward against a seal ring which makes contact directly with the compression cylinder. Other conventional sealing mechanisms and designs may also be used for the sealing structure 27.

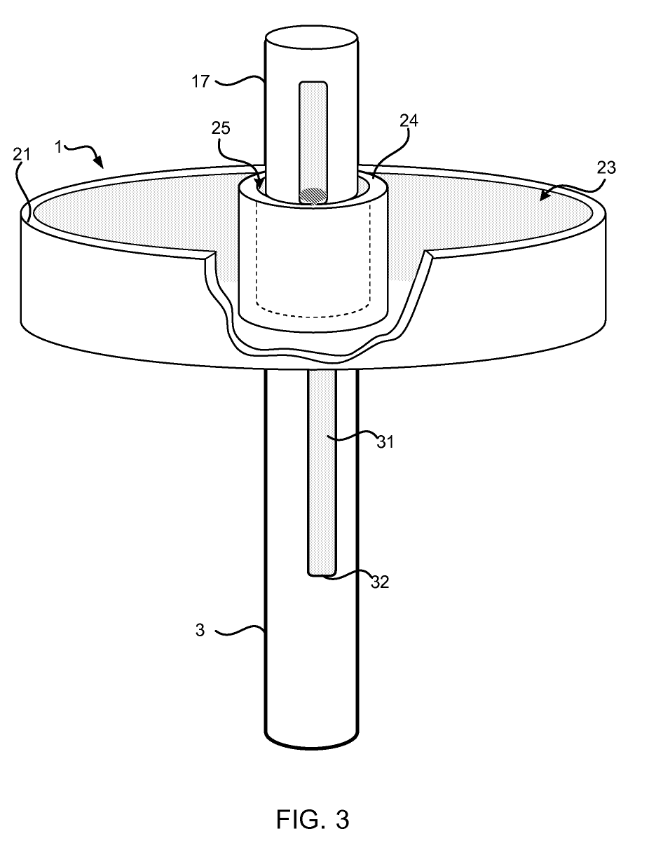

In the embodiment illustrated in FIGS. 2A and 2B, the shaft 10 is coupled to the buoyant mass 1 within a sleeve 24 through which the cylinder extension 17 can fit, as illustrated in FIG. 3. The interior volume 23 in this embodiment is the volume between the outer wall 21 and the sleeve 24. In this embodiment, the shaft 10 is supported and connected to the sleeve 24 by three beams 26 as illustrated in FIG. 2B (although a different number of beams may be used). The sleeve 24 provides an inner cylindrical volume 25 through which the extension cylinder 17 can fit. This embodiment has an advantage that the extension cylinder 17 fitting within the inner cylindrical volume 25 of the sleeve 24 helps to align the piston 2 within the compression cylinder 3.

FIG. 3 illustrates the buoyant mass 1 embodiment in position on the compression cylinder 3 and extension cylinder 17. Vertical channels 31 in the extension cylinder 17 provide openings for the beams 26, while the outside diameter of the extension cylinder 17 fits relatively closely within the sleeve opening 25. The vertical channels 31 allow the buoyant mass 1 to move up and down with the tide and so may be configured long enough to permit the buoyant mass to rise to the highest design tide and lower to the lowest point in the compression stroke. In an embodiment, the beams 26 and the extension cylinder 17 may be sized and configured so that the buoyant mass 1 can be supported by the beams 26 resting on the bottom surface 32 of the vertical channels 32 to accommodate tides below a design level.

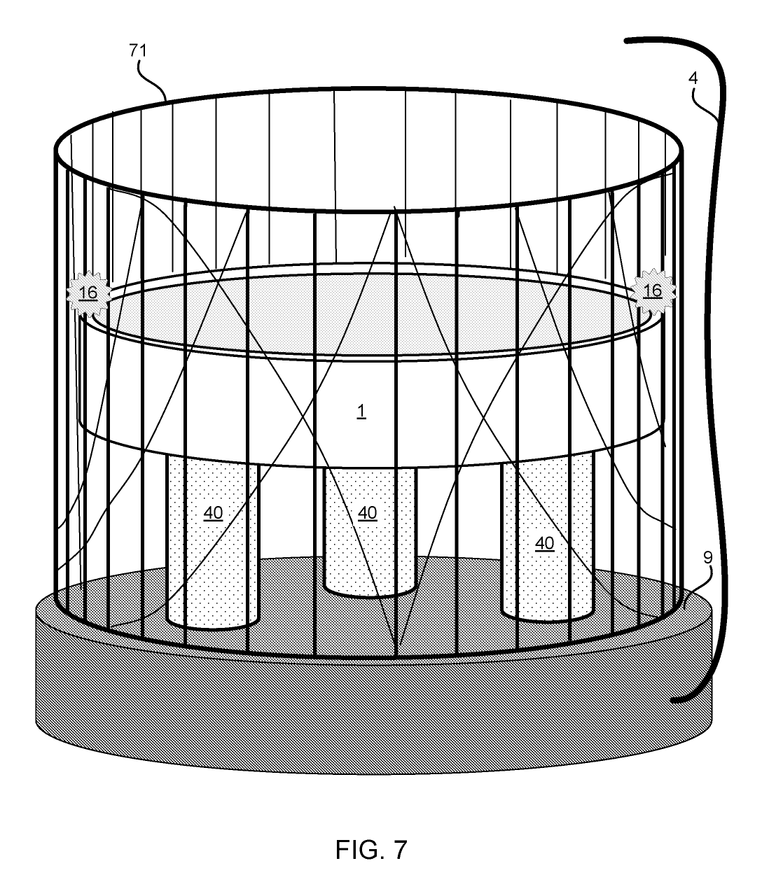

FIG. 4 illustrates an alternative embodiment for the compression member and compression cylinder 3. In this embodiment, the compression member is formed as an inner cylinder 42 which fits tightly into the compression cylinder 3. The inner cylinder 42 may have a closed top surface 41 so that the working fluid is pressurized when the inner cylinder 42 is lowered into the compression cylinder 3. A sealing structure 43, such as those described above with reference to FIG. 2A, may be provided at the bottom of the inner cylinder 42 (or at other positions along its length) to minimize the amount of water that can slip between the two cylinders. Instead of having a closed top surface 41, the bottom of the inner cylinder 42 may be closed. The inner cylinder 42 may also include alignment structures such as bearings, leaf springs and slip rings to facilitate the vertical movement of the inner cylinder 42 within the compression cylinder 3 and prevent binding. This embodiment provides an integrated compression assembly 40 which can be positioned beneath a buoyant mass 1 without need for aligning the mass with the assembly. As such, the integrated compression assembly 40 may be used with a variety of buoyant mass configurations and alignment structures, such as illustrated in the embodiments illustrated in FIGS. 7-10.

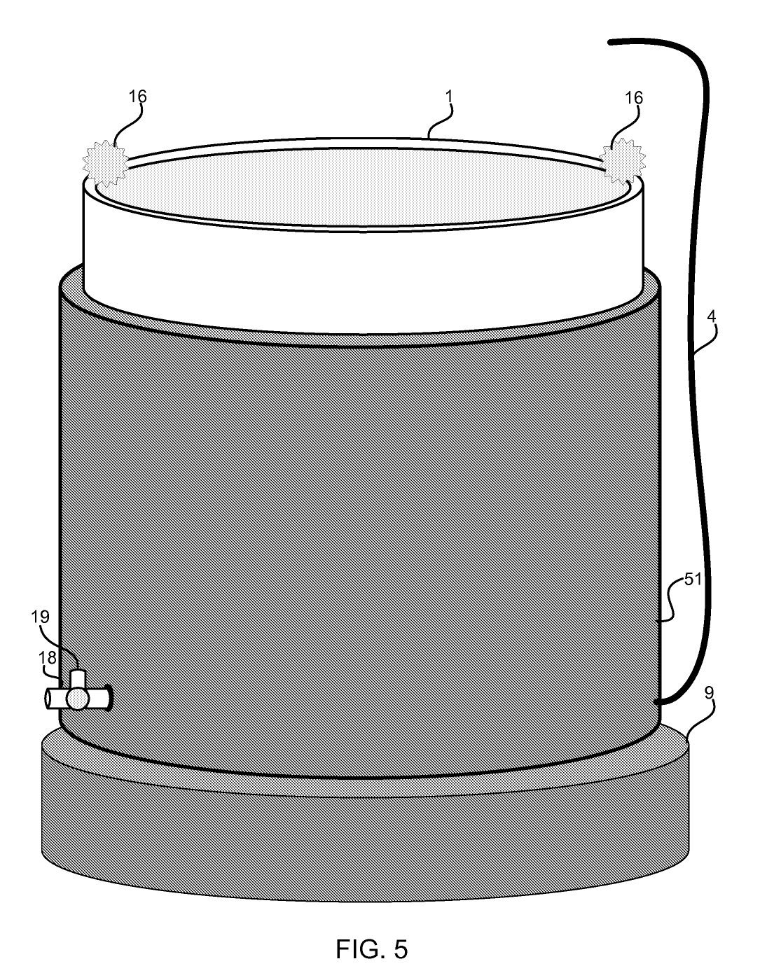

In another embodiment, the buoyant mass 1 may serve as the compression member itself, such as illustrated in FIG. 5. In this embodiment, the compression cylinder is in the form of an external housing 51 which has an inner diameter that closely matches the outer diameter of the buoyant mass 1. The external housing 51 may also rest upon a sufficiently sized foundation 9. As with the embodiment illustrated in FIG. 1, the external housing 51 may include an inlet valve 18 which can allow seawater to enter as the tide rises. As the water level inside the external housing rises, the buoyant mass 1 rises with it until it at or near the top, thereby storing potential energy.

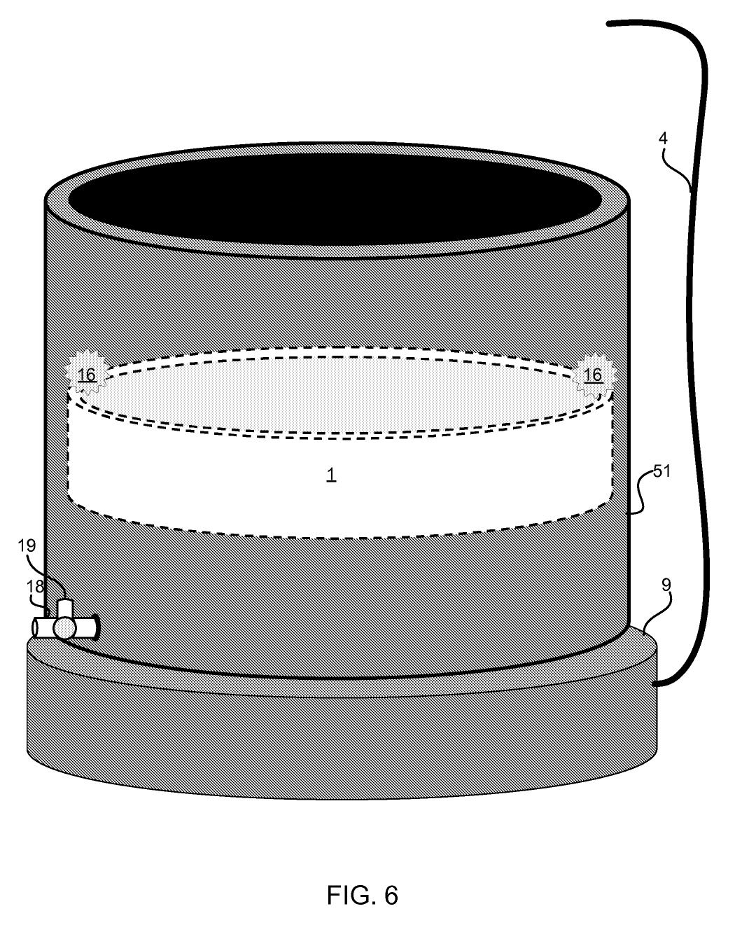

Once the buoyant mass 1 is at or near the top of the external housing 51, the inlet valve 18 may be closed, such as by a remotely controlled actuator 19, and a fluid conduit 4 outlet valve 15 opened to direct seawater to the turbine 5 in order to begin generating power (see FIG. 1 for components not shown in FIGS. 5 and 6). As illustrated in FIG. 6, as seawater is released via the fluid conduit 4, the buoyant mass 1 lowers into the external housing 51, maintaining pressure on the seawater. As in the embodiment illustrated in FIG. 1, mechanical break assemblies 16 may be included to regulate or stop the rate of decent of the buoyant mass 1 so as to store energy for later use and/or regulate the pressure and flow rate of seawater to the turbine 5. As with the embodiment shown in FIG. 1, the level and rate of movement of the buoyant mass 1 may also (or alternatively) be controlled by opening and closing the outlet valve 15 (see FIG. 1).

The embodiment illustrated in FIGS. 5 and 6 has the added advantage of permitting energy to be stored in the elevated position of the buoyant mass 1 through more than one tide cycle. This is because seawater beneath the buoyant mass 1 is regulated by the inlet valve 18. Once the external housing 51 has been filled and the valve 18 closed, the sea level outside the external housing 51 can rise and fall without affecting the buoyant mass 1. Thus, this embodiment may be particularly useful for tidal power systems intended for peak load supplementation.

The external housing 51 may be constructed of any convention material and processes, including for example steel plate and reinforced concrete. In a particular embodiment believed to be most economical, the external housing may be made of reinforced concrete cylinders that are prefabricated (using convention construction methods) and then floated to the site on a barge before being lowered into place. Two or more cylinders may be stacked on top of each other, with preformed joints and seals to permit easy assembly on site.

The buoyant mass 1 may include sealing structures around its circumference, such as those discussed above with reference to FIG. 2A, to reduce vertical water leakage between the buoyant mass 1 and the external housing 51. Also, the buoyant mass 1 and the interior of the external housing 51 may include structures and assemblies to facilitate vertical movement and prevent binding.

In another embodiment, the external housing 51 may be used in combination with the embodiment illustrated in FIG. 1 in order to provide an energy storage capability beyond the span of a single tide cycle. In this embodiment, the external housing 51 may be used to maintain water level below the buoyant mass 1 at the low tide level by closing the inlet valve 18 at low tide. In this manner the buoyant mass 1 can be maintained in the elevated position for more than a tide cycle, allowing the stored potential energy to be extracted via the piston 2 driving working fluid through the compression cylinder 3 whenever the energy is required.

Yet another embodiment is illustrated in FIG. 7 which combines the buoyant mass 1 with a number of compression cylinders or integrated compression assemblies 40 and an external alignment structure 71. In this embodiment, an external alignment structure 71 provides lateral support for the buoyant mass 1, resisting lateral forces from currents, while allowing the buoyant mass 1 to rise and fall with the tide. The external alignment structure 71 may also include structures and be of sufficient strength to support a mechanical breaking systems 16 (or cooperate with mechanical breaking systems mounted on the buoyant mass 1) in order to limit or regulate the downward motion of the buoyant mass 1. The buoyant mass 1 is coupled to multiple integrated compression assemblies 40 which function as described above with reference to FIG. 4. Output from the integrated compression assemblies 40 may be individually routed to different turbines 5 or collected into a single output fluid conduit 4. The inlets and outlets of the integrated compression assemblies 40 may be provided within the compression cylinders 3 themselves, or may be provided within the foundation 9 as illustrated in FIG. 7.

While FIG. 7 shows three integrated compression assemblies 40, any number of such assemblies may be used depending upon the weight of the buoyant mass 1 and the capacity of the integrated compression assemblies 40. By using integrated compression assemblies 40 as building units, the size of the buoyant mass 1 can be increased, and with it the energy generating capacity of the tidal power system can be increased to suit the site. Also, additional compression assemblies 40 can be added to augment the generating capacity.

The external alignment structure 71 can be fabricated from conventional materials, such as steel and/or aluminum beams, using conventional assembly methods. The external alignment structure 71 may be fabricated onsite, partially prefabricated in segments that are assembled onsite, or entirely preassemble and lowered onto the foundation 9 at the site.

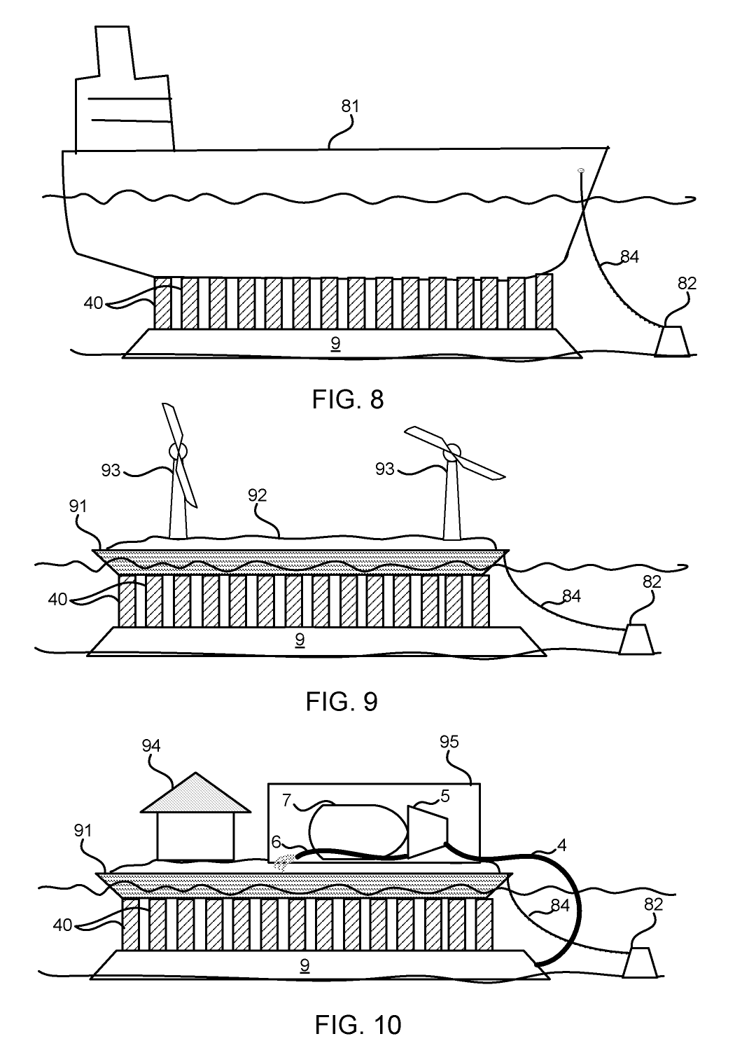

As mentioned above, the buoyant mass 1 can be of any shape or configuration. FIGS. 8-10 illustrate three example embodiments of different configurations which provide different opportunities for utilizing existing structures or providing additional capabilities beyond generating electricity.

As one example, the buoyant mass may be a ship 81 such as a retired freighter as illustrated in FIG. 8. To use a ship 81 as the buoyant mass, the ship 81 can be floated over a plurality of integrated compression assemblies 40 coupled to a foundation 9. Once in position, the ship 81 can be moored, such as by means of anchors 82 and mooring chains 84 to hold it in position. Once moored in place, the ship 81 can be ballasted (e.g., with bulk or water) to lower it until it contacts the integrated compression assemblies 40. At this point, the ship 81 and the integrated compression assemblies 40 can be coupled together (e.g., welding or cables) so that when the ship 81 rises it can raise the integrated compression assemblies 40. Alternatively, the ship 81 can remain disconnected from the integrated compression assemblies 40, providing downward-only pressure when the tide drops. When the tide raises the ship 81 off of the integrated compression assemblies 40, water can be pumped into the compression cylinders 3 to extend them to prepare for the power stroke. Pumps for recharging the integrated compression assemblies 40 may be located on land or onboard the ship 81 itself. Additionally, turbines 5 and generators 7 may also be located on the ship 81. In this manner, the mass of the turbines, generators and related power station equipment add to the weight lifted by the tide and applied to the integrated compression assemblies 40 to generate electricity.

Similarly, FIG. 9 illustrates an embodiment in which a bulk carrier barge 91 serves as the buoyant mass. Like ships, used bulk carrier barges are readily available so a used barge 91 may be an affordable structure. Assembly of this embodiment is similar to that of the embodiment illustrated in FIG. 8. An empty barge 91 is towed into position over a plurality of integrated compression assemblies 40 coupled to a foundation 9. Once in position, the barge 91 can be moored, such as by means of anchors 82 and mooring chains 84. Once moored in place, the barge 91 can be ballasted, such as by filling it with dirt 92 or water to lower it until it contacts the integrated compression assemblies 40. As with a ship, the barge 91 may be connected to the integrated compression assemblies 40 or left free of the assemblies, providing downward only pressure when the tide drops. Pumps for recharging the integrated compression assemblies 40 may be located on land or onboard the barge 91 itself.

In an extension of the embodiment employing a barge 91, the fill dirt 92 may be leveled and useful structures may be built on the surface, such as wind turbines 93 for generating electricity as illustrated in FIG. 9, or buildings 94 and power generating systems 95 as illustrated in FIG. 10. In addition to adding to the weight for purposes of generating power, the structures 94, 95 may allow the barge to serve other useful purposes as well. For example, a power generation system 95 may be built on the barge 91, including a turbine 5 and generator 7. Seawater from the outlet conduit 4 feeds to the turbine 5 and then is released overboard back into the sea from the effluent conduit 6. Only electricity need be transmitted to shore by power lines (not shown in FIG. 10).

The various embodiments may be located adjacent to a seawall or wharf within easy reach of shore facilities. So located, the top surface buoyant mass 1 may be used for other purposes, such as a foundation for structures and the power generating equipment (as illustrated in FIG. 10). Also, the seawall or wharf structures may be used to help stabilize the buoyant mass 1, such as with guide rails and rollers.

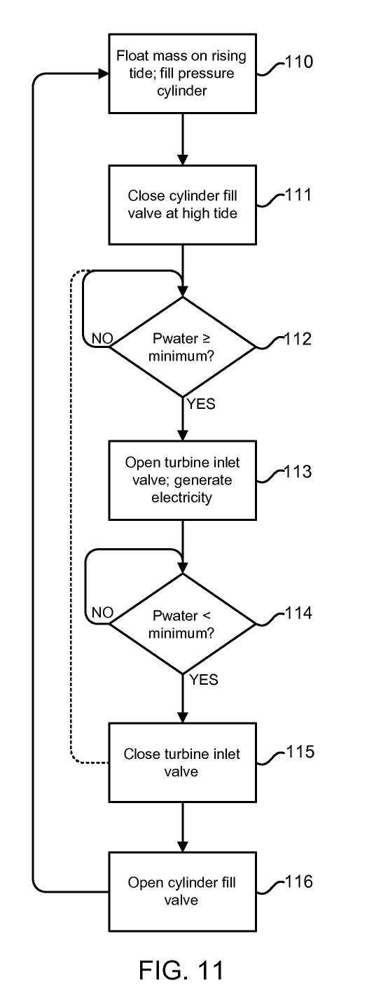

Basic operations of the various embodiments are summarized in FIG. 11. In order to prepare to generate power, the buoyant mass 1 is floated on the rising tide while the compression cylinder 3 is filled with water, step 110. Once the tide is at maximum flood (i.e., at high tide), the inlet valve 18 is closed, step 111. If power is to be generated immediately (instead of at a later time), pressure in the compression cylinder 3, in the outlet conduit 4, or at the outlet valve 15 is monitored to determine if the pressure exceeds the minimum for introduction into the turbine 5, test 112. As long as the pressure is less than the minimum, the outlet valve 15 leading to the turbine 5 remains closed. Once the pressure equals or exceeds the minimum (i.e., test 112=“YES”), the turbine inlet valve 15 is opened which lets in pressurized water, spinning the turbine 5 and generating electricity, step 113. While water is fed to the turbine, the pressure of the water is monitored to determine whether it remains above the minimum pressure for the turbine, test 114. So long as the water pressure remains above the minimum, the turbine inlet valve 15 is left open. However, once the pressure falls below the minimum (i.e., test 114=“YES”), the turbine inlet valve 15 is closed, step 115, thereby terminating the power generation cycle. It is noted that the steps of testing water pressure (tests 112 and 114) and opening and closing the turbine inlet valve 115 (steps 113 and 115) may be performed in a loop in order to regulate turbine inlet pressure as illustrated in the dashed line. Once the buoyant mass 1 reaches the low tide level 12 and will fall no further, the inlet valve 18 to the compression cylinder 3 may be opened, step 116, in order to allow the power cycle to repeat.

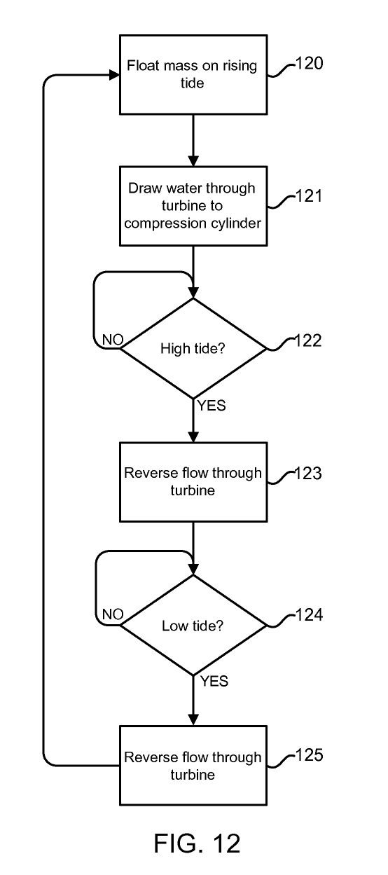

Operation of an alternative embodiment in which power is generated on both rising and falling tides is summarized in FIG. 12. In this embodiment, electricity is generated by floating the buoyant mass on a rising tide, step 120, which draws water through the turbine by the reduced pressure in the compression cylinder formed as the piston is raise by the buoyant mass, step 121. When the tide is at or near high tide, the flow through the turbine is reversed, steps 122 and 123. As the tide falls, the weight of the buoyant mass is applied to the piston raising the pressure of water in the compression cylinder to drive the water through the turbine, step 123. Finally, at or near low tide, the flow through the turbine is reversed, steps 124 and 125, thereby allowing the cycle to repeat.

The foregoing description of the various embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

We claim:

1. A method for generating electricity, comprising:
floating a mass with a rising tide to an elevated position;
applying a weight of the mass to a working fluid; and
directing the working fluid to a turbine coupled to a generator.

2. The method of claim 1, further comprising controlling a rate of descent of the mass in order to regulate a pressure of the working fluid.

3. A tidal power system, comprising:
a buoyant mass;
a compression assembly coupled to the buoyant mass configured to apply a weigh of the buoyant mass to a working fluid;
a turbine configured to receive the working fluid; and
a generator coupled to the turbine.

4. The tidal power system of claim 3, wherein the compression assembly comprises:
a compression cylinder;
a piston positioned within the compression cylinder and coupled to the buoyant mass, wherein the piston and compression cylinder are configured to pressurize water with the compression cylinder beneath the piston.

5. The tidal power system of claim 4, further comprising:
an inlet valve coupled to the compression cylinder;
an outlet conduit fluidically couple to the compression cylinder and to the turbine; and
an output valve coupled to the outlet conduit.

6. The tidal power system of claim 3, further comprising a mechanical breaking system coupled to the buoyant mass configured to limit a descent of the buoyant mass.

7. The tidal power system of claim 3, wherein the compression assembly comprises:
a first cylinder; and
a second cylinder positioned within the first cylinder, the second cylinder having a closed end, whereas the first and second cylinders are configured to compress the working fluid when the weight of the buoyant mass is applied to the second cylinder.

8. The tidal power system of claim 7, further comprising a plurality of compression assemblies.

9. The tidal power system of claim 8, further comprising an external support structure configured to provide lateral support to the buoyant mass.

10. The tidal power system of claim 3, further comprising:
an external housing surrounding the buoyant mass; and
an inlet valve in the external housing, whereas the compression assembly comprises a bottom surface of the buoyant mass and an interior volume of the external housing.

11. The tidal power system of claim 3, wherein the turbine and the generator are position on or within the buoyant mass.

12. The tidal power system of claim 8, wherein the buoyant mass comprises a barge.

13. The tidal power system of claim 8, wherein the buoyant mass comprises a ship.

14. A method of generating electricity using a tidal power system, comprising:
floating a buoyant mass on a rising tide while filing a compression cylinder via an inlet valve;
closing the inlet valve when the tide is at or near maximum flood;
monitoring a pressure of a working fluid in a compression cylinder to which weight of the buoyant mass is applied;
opening an outlet valve to direct the working fluid to a turbine when the working fluid pressure exceeds a threshold;
monitoring the working fluid pressure and closing the outlet valve, stopping flow of the working fluid to the turbine, when the working fluid pressure falls below the threshold; and
opening the inlet valve to the compression cylinder.

15. A method of generating electricity using a tidal power system, comprising:
floating a buoyant mass on a rising tide;
drawing water through a turbine by reduced pressure in a compression cylinder as the buoyant mass raises a piston;
reversing flow through the turbine when the tide is at or near high tide;
applying weight of the buoyant mass to the piston in the compression cylinder to drive water through the turbine; and
reversing flow through the turbine when the tide is at or near low tide.
